(19) United States
(12) Patent Application Publication
(10) Pub. No.: US 2015/0032610 A1
(43) Pub. Date: Jan. 29, 2015

(54) SYSTEM FOR ALTERING BILL PAYMENTS

(71) Applicant: BANK OF AMERICA CORPORATION, Charlotte, NC (US)

(72) Inventors: Stephen R. Crowley, Huntersville, NC (US); Charles Andrews, Huntersville, NC (US); Glenn M. Grossman, Matthews, NC (US)

(73) Assignee: BANK OF AMERICA CORPORATION, Charlotte, NC (US)

(21) Appl. No.: 13/953,243

(22) Filed: Jul. 29, 2013

(51) Int. Cl. G06Q 20/10

(52) U.S. Cl. CPC G06Q 20/102
USPC 705/40

(57) ABSTRACT

Embodiments of the invention are directed to systems, methods and computer program products for altering bill payments. An exemplary apparatus is configured to: determine a customer meets the eligibility requirements for altering bill payments, provide an option for the customer to participate in a service for altering bill payments based at least partially on determining the customer meets the eligibility requirements for altering bill payments, receive a request from the customer to alter one or more bill payments, and alter the one or more bill payments based at least partially on the request to alter one or more bill payments.

### BACKGROUND

While engaging in general business, customers are often required to periodically make payments for services and/or products that have been provided by a particular entity such as a financial institution or merchant. Typically, the payments are associated with an amount and a payment due date that cannot be changed or altered by any means. In some instances, a customer may encounter unforeseen circumstances that prohibit them from being able to make their payment in a timely manner. In these instances, fixed due dates can be quite troublesome, as the customer may encounter additional late payments, increased interest rates, discontinued services and/or the like from missing a single payment arrangement. Furthermore, many entities use a considerate amount of manpower and capital funding resources for services such as loan modifications, by being proactive and allowing customers to facilitate their own payment modifications the entity may save money. Additionally, such an arrangement can also bring value in the eyes of an institution's best customers and boost customer satisfaction and loyalty to the institution.

Therefore, there is a need for a system which allows a customer to alter an online bill payment such that it better suits their current financial situation.

### BRIEF SUMMARY

Embodiments of the invention are directed to systems, methods, and computer program products for altering bill payments. An exemplary apparatus comprises a memory, a processor, and a module stored in the memory, executable by the processor, and configured to: determine a customer satisfies eligibility requirements for altering bill payments, provide an option for the customer to participate in a service for altering bill payments based at least partially on determining the customer meets the eligibility requirements for altering bill payments, receive a request from the customer to alter a bill payment, wherein the bill payment is associated with an original payment arrangement having an original amount due on an original payment due date, and alter the bill payment based at least partially on the request to alter the bill payment.

In some embodiments, the module is further configured to receive a first input from the customer, wherein the first input indicates the bill payment to be altered, receive a second input from the customer, wherein the second input indicates one or more terms for altering the bill payment, and alter the bill payment based at least partially on the one or more terms for altering the bill payment.

In some embodiments, the second input comprises a deferred payment date. In such an embodiment the module is further configured to create a second payment arrangement associated with the bill payment where creating the second payment arrangement comprises scheduling the original amount due to be paid on the deferred payment date, and cancel the original payment arrangement.

In some embodiments, the second input comprises a deferred payment date, an initial payment amount, and a remaining payment amount. In such an embodiment, the module is further configured to alter the original payment arrangement associated with a bill payment wherein altering the original payment arrangement comprises reducing the original amount due to the initial payment amount, and create a second payment arrangement where creating the second payment arrangement comprises scheduling the remaining payment amount to be paid on the deferred payment date.

In some embodiments, the second input comprises a primary deferred payment date, a primary deferred payment amount, at least one secondary deferred payment dates, and at least one secondary deferred payment amounts. In such an embodiment, the module is further configured to create a second payment arrangement associated with the bill payment where creating the second payment arrangement comprises scheduling the primary deferred payment amount to be paid on the primary deferred payment date; and create at least one additional payment arrangement associated with the bill payment where creating the at least one additional payment arrangement comprises scheduling at least one secondary deferred payment amounts to be paid on at least one secondary deferred payment dates, and where the sum of the primary deferred payment amount and the at least one secondary payment amount equals the original amount due, and cancel the original payment arrangement.

In some embodiments, the module is further configured to determine one or more conditions for enrollment, and enroll the customer in a service for altering bill payments based at least partially on the one or more conditions for enrollment.

In some embodiments, the module is further configured to categorize the customer into a tier based at least partially on one more characteristics associated with customer, and the one or more conditions for enrollment are determined based at least partially on the customer's tier.

In some embodiments, the module is further configured to assess one or more financial characteristics associated with the customer to determine the customer meets the eligibility requirements to alter bill payments.

In some embodiments, the module is further configured to assess one or more non-financial characteristics associated with the customer to determine the customer meets the eligibility requirements to alter bill payments.

In some embodiments, the module is further configured to determine the customer does not satisfy at least one eligibility requirement for altering bill payments, provide the customer an offer, where acceptance of the offer results in the customer satisfying the at least one eligibility requirement, and determine the customer satisfies the eligibility requirements for altering bill payments based at least partially on the customer's acceptance of the offer.

In some embodiments, the module is further configured to determine the customer does not satisfy at least one eligibility requirement for altering bill payments, provide the customer an offer, where acceptance of the offer results in the customer satisfying the at least one eligibility requirement, and determine the customer does not satisfy the eligibility requirements for altering bill payments based at least partially on the customer's denial of the offer.

In some embodiments, the module is further configured to verify the customer is eligible to process the request to alter one or more bill payments.

An exemplary method comprises determining a customer satisfies eligibility requirements for altering bill payments, providing an option for the customer to participate in a service for altering bill payments based at least partially on determining the customer meets the eligibility requirements for altering bill payments, receiving a request from the customer to alter a bill payment, where the bill payment is associated with an original payment arrangement having an original amount due on an original payment due date, and altering the bill payment based at least partially on the request to alter the bill payment.

In some embodiments, the method further comprises receiving a first input from the customer, where the first input indicates the bill payment to be altered, receiving a second input from the customer, where the second input indicates one or more terms for altering the bill payment, and altering the bill payment based at least partially on the one or more terms for altering the bill payment.

In some embodiments, the method further comprises, determining the customer does not satisfy at least one eligibility requirement for altering bill payments, providing the customer an offer, where acceptance of the offer results in the customer satisfying the at least one eligibility requirement, and determining the customer satisfies the eligibility requirements for altering bill payments based at least partially on the customer's acceptance of the offer.

An exemplary computer program product for altering bill payments comprises a non-transitory computer-readable medium comprising a set of codes for causing a computer to determine a customer satisfies eligibility requirements for altering bill payments, provide an option for the customer to participate in a service for altering bill payments based at least partially on determining the customer meets the eligibility requirements for altering bill payments, receive a request from the customer to alter a bill payment, wherein the bill payment is associated with an original payment arrangement having an original amount due on an original payment due date, and alter the bill payment based at least partially on the request to alter the bill payment.

In some embodiments, the computer program product further comprises a set of codes for causing a computer to receive a first input from the customer, wherein the first input indicates the bill payment to be altered, receive a second input from the customer, wherein the second input indicates one or more terms for altering the bill payment, and alter the bill payment based at least partially on the one or more terms for altering the bill payment.

In some embodiments, the computer program product further comprises a set of codes for causing a computer to determine the customer does not satisfy at least one eligibility requirement for altering bill payments, provide the customer an offer, wherein acceptance of the offer results in the customer satisfying the at least one eligibility requirement; and determine the customer satisfies the eligibility requirements for altering bill payments based at least partially on the customer's acceptance of the offer.

### BRIEF DESCRIPTION OF THE DRAWINGS

Having thus described embodiments of the invention in general terms, reference will now be made to the accompanying drawings, where:

FIG. 1 is a flowchart illustrating a general process flow for altering bill payments, in accordance with embodiments of the present invention;

FIG. 1B is a flowchart illustrating a general process flow for altering bill payments payable to a third party, in accordance with embodiments of the present invention;

FIG. 2A is a diagram illustrating a method for determining a customer satisfies eligibility requirements, in accordance with embodiments of the present invention;

FIG. 2B is a diagram illustrating a method for determining a customer satisfies eligibility requirements, in accordance with embodiments of the present invention;

FIG. 3 is a flowchart illustrating a general process flow for providing an option for a customer to alter bill payments, in accordance with embodiments of the present invention;

FIG. 4 is a flowchart illustrating a general process flow for receiving a request to alter bill payments, in accordance with embodiments of the present invention;

FIG. 5 is a diagram illustrating a general process flow for altering bill payments, in accordance with embodiments of the present invention; and

FIG. 6 is a diagram illustrating a system environment for altering bill payments, in accordance with embodiments of the present invention

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for altering bill payments payable to a product and/or service provider. For example, in the instance that a customer has unexpectedly lost their job, the invention enables the customer to either opt out of their monthly payment or reschedule the payment for a later date if they are in good standings with the product and/or service provider.

In some embodiments, an “entity” may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by the entity. In other embodiments, an entity may not be a financial institution. In still other embodiments, the entity may be the merchant itself.

In some embodiments, the “customer” may be a customer (e.g., an account holder or a business who has an account (e.g., banking account, credit account, or the like) at the entity) or potential customer or business (e.g., a person who has submitted an application for an account, a person who is the target of marketing materials that are distributed by the entity, a person who applies for a loan that not yet been funded).

In some embodiments an agreement is established between an entity and a customer which involves the customer making arranged payments to the entity in response to receiving a particular product and/or service. The payments may be associated with a payment schedule. As used herein, the payment schedule may be defined by the dates that payments are scheduled to be made on behalf of a customer to a service providing entity. Payment schedules may be either based on predefined parameters or customized. For example, a payment schedule based on predefined parameters may be generated based at least partially on a set of rules that define the frequency of the payments. Parameters and/or payment rules may include, but not be limited to, payment frequency (e.g. annually, semi-annually, quarterly, monthly, weekly, daily, continuous, semi-continuous, and/or the like), payment day (e.g. the day of the month a payment is to be made), rolling date rule (e.g. rules for adjusting the payment date if the scheduled date is not a business day), start date (e.g. date of the first payment), end date (e.g., date of the last payment). A customized payment schedule may be generated based on an agreement between the customer and the service providing entity which specifies the exact dates that one or more payments will be made on behalf of the customer to the entity. As such, the payment frequency associated with a customized payment schedule, in some instances, does not follow a standard pattern.

As used herein, a bill payment arrangement may refer to the date a single payment of an amount, determined by an entity providing a product and/or service, is scheduled to be made payable to entity. In some instances, the product is a debt product and the payment refers to a minimum amount to be paid. A payment schedule may be comprised of one or more payment arrangements.

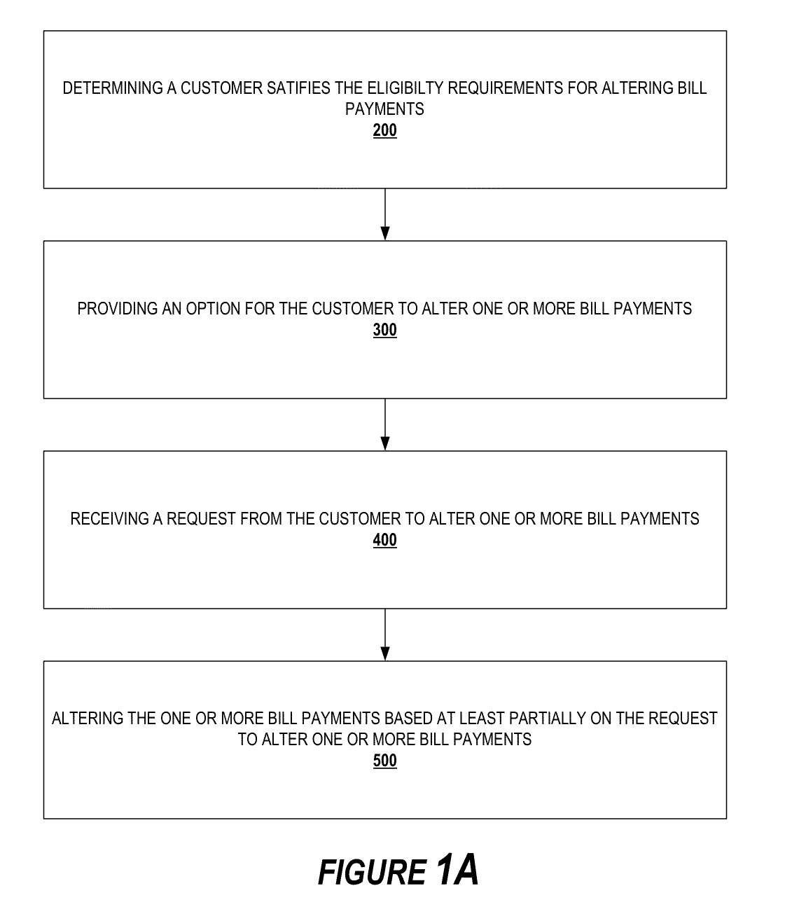

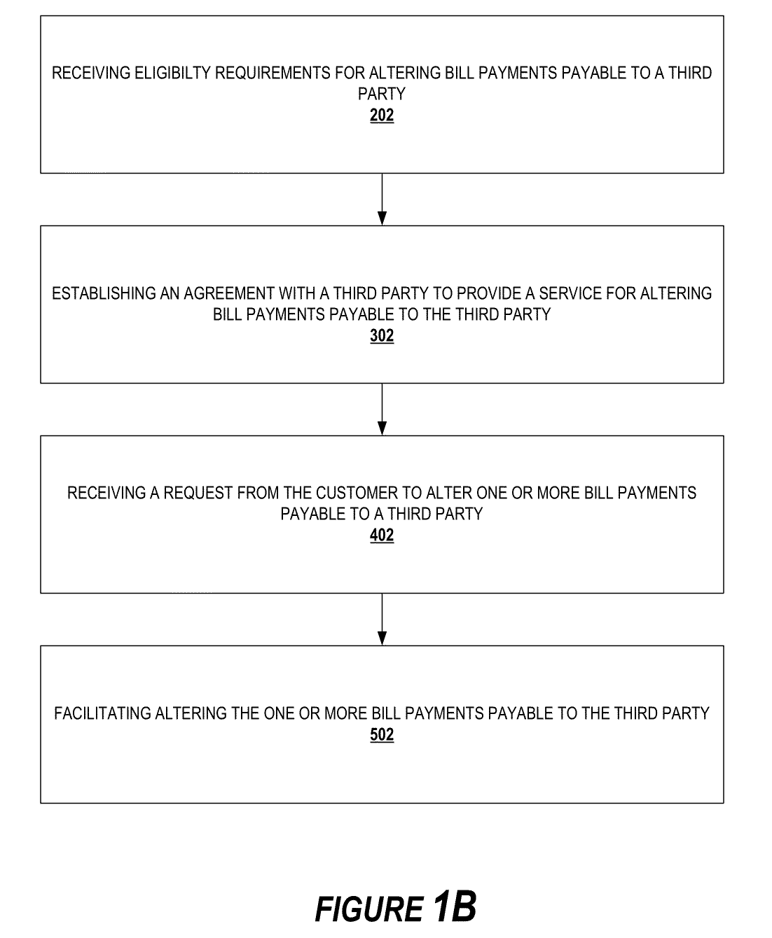

Referring now to FIG. 1A, a general process flow 100 is depicted for altering bill payments, according to embodiments of the present invention. The method may comprise one or more steps including, but not limited to, determining a customer satisfies the eligibility requirements for altering bill payments 200, providing an option for the customer to alter one or more bill payments 300, receiving a request from the customer to alter one or more bill payments 400, and altering the one or more bill payments based at least partially on the request to alter the one or more bill payments 500.

The general process flow 100 may comprise one or more additional steps associated with the general process flow 102, depicted in FIG. 1B, for altering bill payments specifically payable to a third party. The method 102 may comprise the previously mentioned steps of process flow 100 in addition to one or more steps including, but not limited to, receiving eligibility requirements for altering bill payments payable to a third party 202, establishing an agreement with a third party to provide a service for altering bill payments payable to the third party 302, receiving a request from the customer to alter one or more bill payments payable to a third party 402, and facilitating altering the one or more bill payments payable to the third party 502.

At step 200, the method comprises determining that a customer satisfies the predefined requirements and/or criteria for a person to be eligible to alter a bill payment. In a first embodiment an agreement is established between a financial institution and a customer which involves the customer making arranged payments to the financial institution in response to receiving a particular product and/or service provided by the financial institution. The financial institution may be responsible for defining a set of requirements and/or criteria for a customer to be eligible to alter their bill payments, hereinafter referred to as eligibility requirements. The eligibility requirements may be defined prior to the financial institution establishing a service for altering bill payments (hereinafter referred to as “bill payment altering service”) and providing the service to its customers. In this embodiment, eligibility requirements may be related to the relationship of a customer with the financial institution, the financial well-being of the customer, the likelihood of loss associated with doing business with the customer, and or the like.

In a second embodiment an agreement is established, between a merchant and a customer, which involves the customer making arranged payments to the merchant in response to receiving a particular product and/or service provided by the merchant. The financial intuition may provide a service that facilitates altering bill payments payable to a merchant on behalf of a customer. The merchant may be considered a third party entity with respect to a primary relationship established between the financial institution and the customer. Hereinafter, the terms and/or phrases merchant, third party, third party entity, and third party merchant may be used interchangeably throughout the specification. In this embodiment, the third party may be responsible for defining a set of eligibility requirements. Likewise, the financial institution may be responsible for defining a set of eligibility requirements. The eligibility requirements may be defined prior to the financial institution establishing, in conjunction with the third party, a service for altering bill payments made payable to third parties and providing the service to its customers. In some embodiments, the eligibility requirements may be defined by both the third party and the financial institution. As such, eligibility requirements may be related to the relationship of a customer with the third party or the financial institution, customer financial well-being, likelihood of loss associated with doing business with the customer, and or the like.

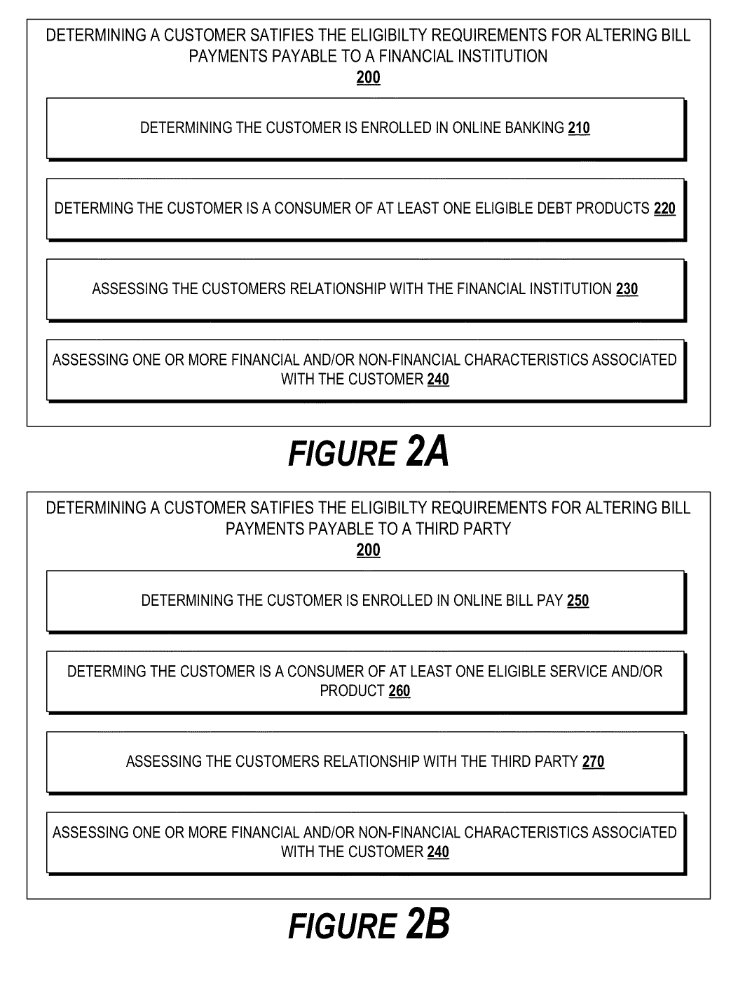

As illustrated in FIG. 2, determining that a customer satisfies the eligibility requirements for altering bill payments, at step 200, may comprise one or more additional method steps. In the first embodiment illustrated in FIG. 2A, in which payments are made payable to a financial institution, the additional method steps may include, but not be limited to, determining the customer is enrolled in online banking 210, determining the customer is a consumer of at least one eligible service and/or product 220, assessing the customer's relationship with the financial institution 230, and/or assessing one or more financial and/or non-financial characteristics associated with the customer 240.

At step 210, the system determines whether or not the customer is enrolled in online banking. In one embodiment, the system may automatically determine the customer satisfies at least one eligibility requirement for altering bill payments in response to determining the customer is enrolled in online banking. A customer may be considered ineligible to alter their bill payments if it is determined that the customer is not enrolled in an online banking service. In one embodiment, the system may automatically determine the customer does not satisfy at least one eligibility requirements for altering bill payments in response to determining the customer is not enrolled in online banking.

In this embodiment, the method may comprise at least one of the following additional steps including, offering the customer an option to enroll in online banking based at least partially on determining that the customer does not satisfy the eligibility requirements for altering bill payments because they are not enrolled in online banking, receiving the customer's acceptance of the offer to enroll in online banking, enrolling the customer in online banking in response to receiving the customer's acceptance of the offer, and determining the customer satisfies at least one eligibility requirement for altering bill payments based at least partially on the customer's acceptance of the offer and/or determining the customer is now currently enrolled in online banking.

Alternatively, in this embodiment, the method may additionally comprise at least one of the following alternative steps including, offering the customer an option to enroll in online banking based at least partially on determining that the customer does not satisfy the eligibility requirements for altering bill payments because they are not enrolled in online banking, receiving the customer's denial of the offer to enroll in online banking, and determining the customer does not satisfy the eligibility requirements for altering bill payments based at least partially on the customer's denial of the offer to enroll in online banking.

At step 220, the system determines whether or not the customer is a consumer of at least one eligible debt product provided by the financial institution. Eligible debt products may include, but not be limited to, personal loans, commercial and/or business loans, mortgages, credit cards, and the like. In some embodiments, the customer may be eligible for different benefits associated with the service based on the type(s) of debt product(s) they have. In one embodiment, the system may automatically determine the customer satisfies at least one eligibility requirements for altering bill payments in response to determining the customer is a consumer of at least one eligible debt product. A customer may be considered ineligible to alter their bill payments if it is determined that the customer is not a consumer of at least one eligible debt products. In one embodiment, the system may automatically determine the customer does not satisfy the eligibility requirements for altering bill payments in response to determining the customer is not a consumer of at least one eligible debt products.

In this embodiment, the method may comprise at least one of the following additional steps including, providing the customer an offer to apply for an eligible debt product based at least partially on determining the customer does not satisfy the eligibility requirements for altering bill payments because they are not a consumer of at least one eligible debt product, receiving the customer's acceptance of the offer to apply for an eligible debt product, providing the customer an application for the eligible debt product in response to receiving the customer's acceptance of the offer, receiving the customer's application for the eligible debt product, processing the customer's application for the eligible debt product, and determining the customer satisfies the eligibility requirements for altering bill payments based at least partially on the customer being approved for the eligible debt product. Likewise, the system may be cable of determining the customer does not satisfy the eligibility requirements for altering bill payments based at least partially on the customer being denied for the eligible debt product.

Alternatively, in this embodiment, the method may additionally comprise at least one of the following alternative steps including, providing the customer an offer to apply for an eligible debt product based at least partially on determining the customer does not satisfy the eligibility requirements for altering bill payments because they are not a consumer of at least one eligible debt product, receiving the customer's denial of the offer to apply for an eligible debt product, and determining the customer does not satisfy the eligibility requirements for altering bill payments based at least partially on the customer's denial of the offer to apply for an eligible debt product.

For example, a financial institution may define an eligible debt product as a premier credit card, whereas a standard credit card may be considered an ineligible debt product. As used herein, a premier credit card may refer to a credit card issued by a financial intuition that possesses benefits exclusive to its users. A customer that only has a standard credit card issued by the financial institution may be interested in altering an upcoming bill payment. In response to determining the customer is not a consumer of at least one eligible debt product, the system offers the customer an offer to apply for a premier credit card issued by the financial institution. Upon receiving the customer's acceptance of the offer, the system then provides and/or presents the customer with an application to apply for the premier credit card. After receiving and processing the application, the customer's eligibility for altering bill payments is reassessed and the system determines whether or not the customer satisfies the eligibility requirements based at least partially on their application for the premier credit card being approved or denied. Likewise, the system may automatically determine the customer does not satisfy the eligibility requirements for altering bill payments if he/she declines the offer to apply for a platinum credit card.

In some embodiments, only bill payments associated with eligible debt products may be altered. Alternatively, in other embodiments, the customer may alter bill payments associated with any debt product if they are a consumer of at least one eligible debt product and at least a portion of the exclusive benefits, such as altering bill payments, associated with the eligible debt product may be extended to all of their debt products. With respect to the previous example, in the first instance, the customer would not be able to alter the current bill payment of their standard credit card in response to being approved for a premier credit card. They would however be eligible to alter future payments associated with their new premier credit card. In the second instance, the customer would be able to alter the current bill payment of their standard credit card in response to applying and being approved for a premier credit card. In yet another embodiment, the system may allow the customer to charge a bill payment associated with an ineligible debit product to an eligible debt product, and subsequently alter the bill payment after it has been charged to the eligible debt product. With respect to the first instance of the previous example, the customer can charge the current bill payment associated with their standard credit card to their new premier credit card, and then alter the bill payment after it has been charged to the premier credit card.

At step 230, the system assesses the customer's relationship with the financial institution as customer eligibility may be based upon various factors related to the customer's relationship with the financial institution. For example, these factors may include, but not be limited to, whether or not the customer is currently in good standings with financial institution or has an overall reputable and/or favorable relationship or history with the financial institution, and how often or to what degree the customer engages in business with the financial institution.

Assessing the customer's relationship with the financial institution may further comprise receiving information associated with one or more of the customer's financial institution account(s). In some embodiments, the account information comprises a transaction history associated with the customer's financial institution account. The transaction history includes the types of transactions, frequency of transactions, amount of each transaction, merchants associated with transactions, account balance history, etc. Additionally or alternatively, the account information may comprise information associated with incorrect, inconsistent, incomplete, or corrupted transactions. In some embodiments customer information may be received from one or more financial institutions across a plurality of different financial products. For example, in one embodiment, the system receives information from the financial institution about a plurality of different financial products that the user is taking advantage of at that institution. For example, the user may have a checking account, savings account, investment account, mortgage, education loan, car loan, personal loan, credit card account, and/or the like maintained by the financial institution. In some embodiments, the system also receives financial information about the user from one or more other financial institutions with which the customer does business.

In some instances a server associated with the financial institution may gather and store the customer's financial institution account information such that the information is available to the server for later analysis. Customer eligibility may be based on account information gathered from a specific/predetermined period of time or based on a specific parameter, such as the account and/or transaction type. The account information may be associated with one or more categories prior to being stored so that the financial institution may be selective in determining which analytics are used to determine the customer's eligibility for altering bill payments. Categories may be related to years, months, weeks, days, fiscal quarters, transaction parameters, account types, and or the like. For example, a customer is engaged in business with a financial institution for ten (10) years. Throughout this timer the financial institution continuously stores information related to the customer's financial account(s) history for that past ten (10) years and categorizes the information based on which year the information was obtained. When determining whether or not the customer satisfies the eligibility requirements for altering bill payments the financial institution may choose to not assess the customer's entire financial history, but only the customers relationship with the financial institution for the past two (2) years. The system may then gather information from the categories related to the past two (2) years in which the customer has done business with the financial institution.

Assessing the customer's relationship with the financial institution may further comprise determining whether or not the customer has a favorable relationship with the financial institution based on the customer's financial institution account history. In one embodiment, the system may automatically determine the customer satisfies at least one eligibility requirements for altering bill payments in response to determining the customer has a favorable relationship with the financial institution. A customer may be considered ineligible to alter their bill payments if it is determined that the customer does not have a favorable relationship with the financial institution. In one embodiment, the system may automatically determine the customer does not satisfy the eligibility requirements for altering bill payments in response to determining the customer does not have a favorable relationship with the financial institution.

In some embodiments, a customer is considered to have a favorable relationship with the financial institution if, in the past, they have made payments to the financial institution in a timely fashion. In some embodiments, a customer is considered to have a favorable relationship with the financial institution if, in the past, they maintain one or more account balances above a predetermined amount. The financial institution may additionally use any degree of lenience in defining the parameters of a “favorable” relationship. In one embodiment, a customer may be determined to have a favorable relationship if, during a predetermined time period, they have not made more than a predetermined number of late payments to the financial institution.

In this embodiment, the method may comprise at least one of the following additional steps including, receiving the customer's financial institution account history from a predetermined time period, analyzing the customer's financial institution account history to determine how many late payments the customer has made to the financial institution, determining based at least partially on the analysis that the number of late payments the customer has made to the financial institution does not exceed a predetermined number, and determining the customer satisfies the eligibility requirement for altering bill payments based at least partially on determining the customer has not exceeded a predetermined number of late payments. Likewise, the system may be cable of determining the customer does not satisfy the eligibility requirements for altering bill payments based at least partially on determining the customer has exceeded making a predetermined number of late payments.

For example, the financial institution may define a favorable relationship as any customer who has not made more than three (3) late payments within the past six (6) months. The system gathers and/or receives the customer's financial institution account history from the past six (6) months and analyzes the information to determine that the customer has not made any late payments. The system can then determine that the customer satisfies the eligibility requirements for altering bill payments based at least partially on determining that the customer has made less than three (3) late payments in the past six (6) months. Likewise, for a customer that has three (3) or more late payments in the past six months, the system may determine the customer does not satisfy the eligibility requirements for altering bill payments based at least partially on determining the customer has made three (3) or more late payments in the past six (6) months.

In some embodiments, a customer is considered to have a favorable relationship with the financial institution if they have at least a predetermined number of services and/or products maintained/provided by the financial institution or a certain type of services and/or products provided by the financial institution. In some embodiments, customers with a favorable relationship with the financial institution, and more specifically customers that are highly engaged in business with the financial institution may be considered “preferred customers”. In one embodiment, a customer may be determined to have a favorable relationship if they have at least a predetermined number of credit cards maintained by the financial institution. In this embodiment, the method may comprise receiving information associated with the customer's financial institution accounts, analyzing the information to determine how may credit cards the customer has, and determining the customer satisfies the eligibility requirement for altering bill payments based at least partially on determining the customer has at least a predetermined number of credit cards. Likewise, the system may be cable of determining the customer does not satisfy the eligibility requirements for altering bill payments based at least partially on determining the customer does not have at least a predetermined number of credit cards.

In this embodiment, the method may comprise at least one of the following additional steps including, providing the customer an offer to apply for a credit card maintained by the financial institution, receiving the customer's acceptance of the offer to apply for a credit card, providing the customer an application for a credit card in response to receiving the customer's acceptance of the offer, receiving the customer's application for the credit card, processing the customer's application for the credit card, and determining the customer satisfies the eligibility requirements for altering bill payments based at least partially on the customer being approved for the credit card. Likewise, the system may be cable of determining the customer does not satisfy the eligibility requirements for altering bill payments based at least partially on the customer being denied for the credit card.

Alternatively, in this embodiment, the method may additionally comprise at least one of the following alternative steps including, providing the customer an offer to apply for a credit card maintained by the financial institution, receiving the customer's denial of the offer to apply for a credit card, and determining the customer does not satisfy the eligibility requirements for altering bill payments based at least partially on the customer's denial of the offer to apply for a credit card maintained by the financial institution.

For example, the financial institution may define a favorable relationship as any customer who has a checking account, savings account, and at least one investment product with the financial institution. The system gathers and/or receives the customer's information associated with their financial institution account and analyzes the information to determine the customer has a checking and savings account, but does not have at least one investment products. The system can then provide the customer an offer to offer to open an Individual Retirement Account (IRA) provided by the financial institution, receive the customer's acceptance of the offer to open an IRA, open an IRA on behalf of the customer in response to receiving the acceptance of the offer, and determining the customer satisfies the eligibility requirements for altering bill payments based at least partially on the customer accepting the offer to open an IRA and currently having at least one investment product maintained by the financial institution. Likewise, the customer may deny the offer to open an IRA and the system may determine the customer does not satisfy the eligibility requirements for altering bill payments based at least partially on receiving the customer's denial of the offer to open an IRA provided by the financial institution.

At step 240, the system assesses one or more financial and/or non-financial characteristics associated with the customer. Financial characteristics may include, but not be limited to, a customer's credit score, annual income, salary, and the like. Non-financial characteristics may include but not be limited to general demographics and/or other personal information associated with a customer such as their age, sex, residence, and the like.

Assessing one or more financial and/or non-financial characteristics associated with the customer may further comprise receiving personal information associated with the customer. In some embodiments, the personal information may include, but not be limited to demographic information, salary information, contact information (mailing address, email address, phone number, and the like), residence address history, education information, job profile information, and the like. In some embodiments, the personal information further comprises social network information associated with the customer's social network account. In some embodiments, the personal information further comprises information associated with the customer's immediate or extended family members or contacts (e.g., as determined from social network information). In some instances a server associated with the financial institution may gather and store the customer's personal information such that the information is available to the server for later analysis.

Assessing one or more financial and/or non-financial characteristics associated with the customer may further comprise determining likelihood of loss associated with doing business with the customer based on one or more of the customer's financial and/or non-financial characteristics. In one embodiment, the system may automatically determine the customer satisfies at least one eligibility requirements for altering bill payments in response to determining the likelihood of loss associated with doing business with the customer is relatively low. A customer may be considered ineligible to alter their bill payments if it is determined that the likelihood of loss associated with doing business with the customer is relatively high. In one embodiment, the system may automatically determine the customer does not satisfy the eligibility requirements for altering bill payments in response to determining the likelihood of loss associated with doing business with the customer is relatively high. The financial institution may additionally use any degree of lenience in defining the parameters of the likelihood of loss associated with doing business with a particular customer.

In one embodiment, the likelihood of loss associated with doing business with a customer may be defined by whether or not the customer's credit score exceeds a predetermined threshold. The likelihood of loss associated with doing business with customers having a credit score above the predetermined threshold may be considered to be relatively low. The likelihood of loss associated with doing business with customers having a credit score below the predetermined threshold may be considered to be relatively high.

In this embodiment, the method may comprise at least one of the following additional steps including, receiving the customer's detailed credit report comprising a credit score, determining based at least partially on the credit report that the customer's credit score exceeds a predetermined threshold, and determining the customer satisfies the eligibility requirement for altering bill payments based at least partially on determining the likelihood of loss associated with doing business with the customer is relatively low due to their credit score. Likewise, the system may be cable of determining based at least partially on the credit report that the customer's credit score does not exceed a predetermined threshold, and determining the customer does not satisfy the eligibility requirement for altering bill payments based at least partially on determining the likelihood of loss associated with doing business with the customer is relatively high due to their credit score.

For example, the financial institution may define the predetermined threshold as six-hundred and fifty (650). The system would first gather and/or receives a detailed credit report for the customer. The system can then determine that the customer satisfies the eligibility requirement for altering bill payments based at least partially on determining that the customer's credit score is a seven hundred (700), which exceeds the predetermined threshold, and thereby indicates the likelihood of loss associated with doing business with the customer is relatively low. Likewise, the system can determine that a customer does not satisfy the eligibility requirement for altering bill payments based at least partially on determining that the customer's credit score is a six hundred (600), which does not exceed the predetermined threshold, and thereby indicates the likelihood of loss associated with doing business with the customer is relatively high.

In an embodiment where the eligibility requirements are at least partially defined by the third party, at step 202, the system may receive from the third party eligibility requirements for altering bill payments payable to a third party. As such, in the second embodiment illustrated in FIG. 2B, in which payments are made payable to a third party, the additional method steps may include, but not be limited to, determining the customer is enrolled in online bill pay 250, determining the customer is a consumer of at least one eligible service and/or product 260, assessing the customer's relationship with the third party 270, and/or assessing one or more financial and/or non-financial characteristics associated with the customer 240. The eligibility requirements may be assessed by the financial institution, the third party, or a combination of both entities.

At step 250, the system determines whether or not the customer is enrolled in online bill pay. In one embodiment, the system may automatically determine the customer satisfies at least one eligibility requirement for altering bill payments in response to determining the customer is enrolled in online bill pay. A customer may be considered ineligible to alter their bill payments if it is determined that the customer is not enrolled in an online bill pay service. In one embodiment, the system may automatically determine the customer does not satisfy at least one eligibility requirements for altering bill payments in response to determining the customer is not enrolled in online bill pay.

In this embodiment, the method may comprise at least one of the following additional steps including, offering the customer an option to enroll in online bill pay based at least partially on determining that the customer does not satisfy the eligibility requirements for altering bill payments because they are not enrolled in online bill pay, receiving the customer's acceptance of the offer to enroll in online bill pay, enrolling the customer in online bill pay in response to receiving the customer's acceptance of the offer, and determining the customer satisfies at least one eligibility requirement for altering bill payments based at least partially on the customer's acceptance of the offer and/or determining the customer is now currently enrolled in online bill pay.

Alternatively, in this embodiment, the method may additionally comprise at least one of the following alternative steps including, offering the customer an option to enroll in online bill pay based at least partially on determining that the customer does not satisfy the eligibility requirements for altering bill payments because they are not enrolled in online bill pay, receiving the customer's denial of the offer to enroll in online bill pay, and determining the customer does not satisfy the eligibility requirements for altering bill payments based at least partially on the customer's denial of the offer to enroll in online bill pay.

At step 260, the system determines whether or not the customer is a consumer of at least one eligible service and/or product provided by the third party. Eligible services and/or products may be associated with communication, networking, entertainment, consulting, legal services, real estate, education, standard utilities and the like. In one embodiment, the system may automatically determine the customer satisfies at least one eligibility requirements for altering bill payments in response to determining the customer is a consumer of at least one eligible service and/or product. A customer may be considered ineligible to alter their bill payments if it is determined that the customer is not a consumer of at least one eligible service and/or products. In one embodiment, the system may automatically determine the customer does not satisfy the eligibility requirements for altering bill payments payable to the third party in response to determining the customer is not a consumer of at least one eligible service and/or product provided by the third party.

In this embodiment, the method may comprise at least one of the following additional steps including, providing the customer an offer to apply for an eligible service and/or product based at least partially on determining the customer does not satisfy the eligibility requirements for altering bill payments because they are not a consumer of at least one eligible service and/or product, receiving the customer's acceptance of the offer to apply for an eligible service and/or product, providing the customer an application for the eligible service and/or product in response to receiving the customer's acceptance of the offer, receiving the customer's application for the eligible service and/or product, processing the customer's application for the eligible service and/or product, and determining the customer satisfies the eligibility requirements for altering bill payments based at least partially on the customer being approved for the eligible service and/or product. Likewise, the system may be cable of determining the customer does not satisfy the eligibility requirements for altering bill payments based at least partially on the customer being denied for the eligible service and/or product.

Alternatively, in this embodiment, the method may additionally comprise at least one of the following alternative steps including, providing the customer an offer to apply for an eligible service and/or product based at least partially on determining the customer does not satisfy the eligibility requirements for altering bill payments because they are not a consumer of at least one eligible service and/or product, receiving the customer's denial of the offer to apply for an eligible service and/or product, and determining the customer does not satisfy the eligibility requirements for altering bill payments based at least partially on the customer's denial of the offer to apply for an eligible service and/or product.

For example, a cable and communications company may define an eligible service and/or product as a bundle service which provides cable, internet and telephone services to a customer, whereas a single service by itself may be considered an ineligible service and/or product. A customer that only has cable and internet services may be interested in altering an upcoming bill payment. In response to determining the customer is not a consumer of at least one eligible service and/or product, the system offers the customer an offer to receive a telephone service provided by the company. Upon receiving the customer's acceptance of the offer, the system then provides and/or presents the customer with an application for the telephone service. After receiving and processing the application, the customer's eligibility for altering bill payments is reassessed and the system determines whether or not the customer satisfies the eligibility requirements based at least partially on their application for the premier credit card being approved or denied. Likewise, the system may automatically determine the customer does not satisfy the eligibility requirements for altering bill payments if he/she declines the offer to receive a new telephone service.

At step 270, the system assesses the customer's relationship with the third party as customer eligibility may be based upon various factors related to the customer's relationship with the third party. In some embodiments, the customer's relationship with the third party may be related to information provided by the third party or indicated in the user's financial history. For example, if the user has a history of not timely making their utility payments the financial institution may determine they are ineligible to alter payments to a particular third party.

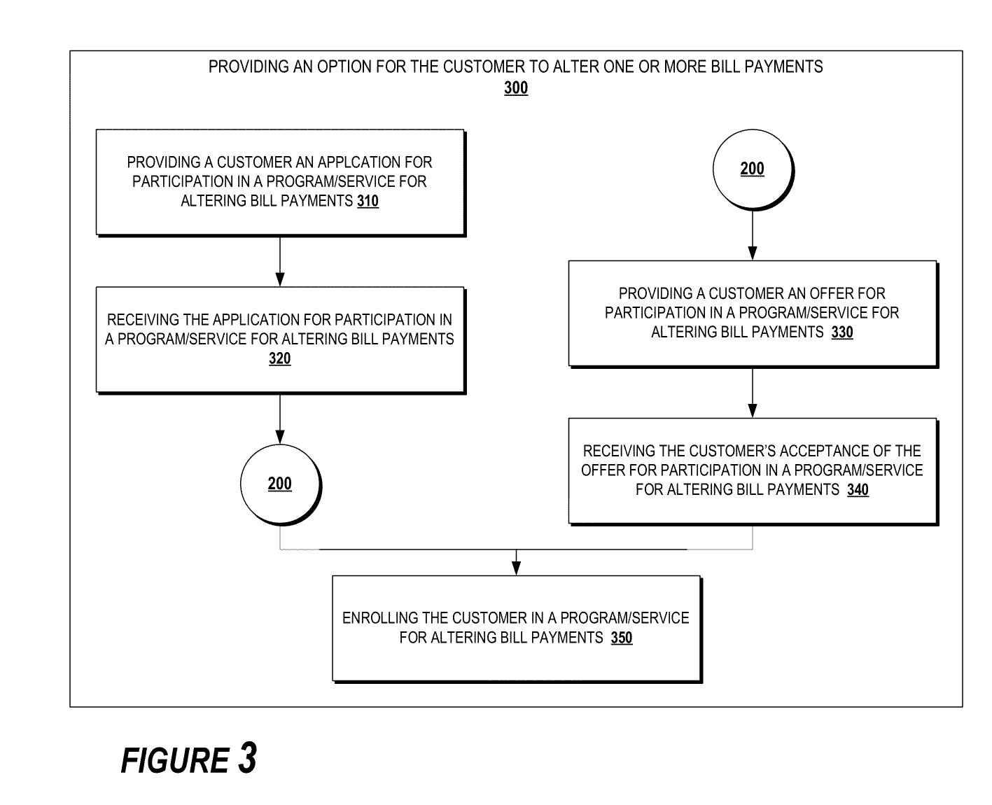

As further illustrated in FIG. 1, at step 300, the method comprises providing an option for the customer to alter one or more bill payments. In some embodiments, the option is presented based at least partially on determining the customer meets the eligibility criteria for altering bill payments. It should be noted that, while step 300 may be depicted subsequent to step 200, step 300 may be executed prior to step 200, as illustrated in FIG. 3. As such, in other embodiments, the system may determine the customer meets the eligibility criteria for altering bill payments in response to providing an option for the customer to alter one or more bill payments.

Altering bill payments may be associated with a customer's participation in a program, established by the financial institution, which provides a service for altering bill payments exclusively to the customers enrolled in and/or participating in the program. In an embodiment where an agreement is established, between a merchant and a customer, which involves the customer making arranged payments to the merchant in response to receiving a particular product and/or service provided by the merchant, the financial intuition may provide a service that facilitates altering bill payments payable to a merchant on behalf of a customer. At step 302, an agreement is established between the financial institution and the third party to provide a service where the financial institution may facilitate a customer altering one or more bill payments payable to the third party. The service for altering bill payments payable to a third party may comprise the financial institution guaranteeing the third party a particular payment in response to the third party agreeing to alter one or more of a customer's bill payments, or the financial institution paying the third party up front, on behalf of the customer, and the customer repaying the financial institution at a later date. In some embodiments, the financial institution guaranteeing the third party payment on behalf of the customer may be associated with a service payment paid by the third party to the financial institution for use of the service. The agreement between the financial institution and the third party may be made independent of the customer to which the service may be provided.

As illustrated in FIG. 3, providing an option for the customer to alter the one or more bill payments, at step 300, may comprise one or more additional method steps. The additional method steps may include, but not be limited to, providing a customer an application for participation in a program/service for altering bill payments 310, receiving the application for participation in the program/service for altering bill payments, determining the customer satisfies the eligibility requirements for altering bill payments 200, and enrolling the customer in the program/service for altering bill payments based at least partially on determining the customer satisfies the eligibility requirements for altering bill payments 350. Alternatively, the additional method steps may include, but not be limited to, determining the customer satisfies the eligibility requirements for altering bill payments 200, providing the customer an offer for participation in a program/service for altering bill payments 330 based at least partially on determining the customer satisfies the eligibility requirements for altering bill payments, receiving the customer's acceptance of the offer for participation in the program/service for altering bill payments 340, and enrolling the customer in the program/service for altering bill payments based at least partially on receiving acceptance of the offer for participation in the program/service 350.

In some embodiments, the option for the customer to alter one or more bill payments may be provided in conjunction with another product and/or service. For example, if a user purchases a life insurance policy maintained by the financial institution they may automatically be presented an option to either apply for or enroll in the program for altering bill payment.

In some embodiments, providing an option for the customer to alter one or more bill payments and/or enrolling the customer in a program for altering bill payments may be accompanied by a service payment. The service payment may be paid as a one-time payment, monthly, yearly, annually, and the like, based upon the customer's eligibility for the program. For example, a customer may purchase a one-time buy of the service that may be used to alter a single payment arrangement if the customer experiences an emergency during any given month. The customer may be required to pay the service payment when initially enrolling in the program, or at time of use. In some embodiments, a customer may be offered the service at no-charge, such as if the customer is considered a preferred customer by the financial institution. In some embodiment, the amount of the service payment may vary based upon various factors. For example, a customer deferring a payment for ten (10) days may be charged a lower service payment than a customer deferring a payment for thirty (30) days. In other embodiments, the customer may agree to pay a specified interest rate for altering a bill payment versus the standard interest rate.

At step 310, the system provides the customer an application for participation in a program/service for altering bill payments. The application may be provided in response to the customer indicating a need for the flexibility of altering bill payments. In some embodiments, providing the customer an application may further comprise presenting the application via a graphical display. The application may be presented in the graphical user interface (GUI) associated with online banking platform. At step 320, a completed application is received from the customer. In an embodiment where the application is presented via a graphical display, the application may be received in response to the customer selecting to submit the application to an entity for processing. The customer may be additionally prompted to agree to one or more terms and conditions associated with processing the application. For example, the terms and conditions may specify the customer is granting, the financial institution and/or an entity responsible for processing the application, access to the their personal data, such as a financial history. In some embodiments, a customer failing to agree to the terms and conditions may result in the application being automatically denied prior to being processed.

After receiving the application the method may further comprise processing the application to determine whether or not the customer is approved or denied for enrollment into the program. Processing the customer's application may include, step 200, determining the customer satisfies the eligibility requirements for altering bill payments. In some instances, the customer's application may be denied based upon the customer failing to satisfy an eligibility requirement. Eligibility requirements may be based on fixed variables and/or unfixed variables. As used herein, fixed variables may refer to customer characteristics based on a long-term or established history (e.g. credit score), and unfixed variables may refer to customer characteristics that can be easily altered (e.g. not being enrolled in online banking).

In some embodiments, if it is determined that the customer does not satisfy an eligibility requirement associated with a unfixed variable the method may comprise at least one of the following additional steps including, temporarily denying the application based at least partially on determining the customer does not satisfy an eligibility requirement associated with an unfixed variable, offering the customer an option to satisfy the eligibility requirement, receiving the customer's acceptance of the offer to satisfy the eligibility requirement, altering the unfixed variable to satisfy the eligibility requirement in response to receiving the customers' acceptance of the offer, and approving the application based at least partially on the customer's acceptance of the offer and/or determining the customer now satisfies the eligibility requirement on which the temporary denial was based. In some embodiments, the system may provide the customer a detailed alert which indicates that the application has been temporarily denied based on the user failing to satisfy an eligibility requirement associated with an unfixed variable, prior to offering the customer an offer to satisfy the eligibility requirement. Likewise, the system may be capable of receiving the customer's denial of the offer to satisfy the eligibility requirement, and automatically denying the application in response to the customer's denial of the offer.

In other embodiments, if it is determined that the customer does not satisfy an eligibility requirement associated with a fixed variable the method comprises automatically denying the application based at least partially on determining the customer does not satisfy an eligibility requirement associated with an fixed variable, and provide the customer a detailed alert which indicates that the application has been denied based on the user failing to satisfy an eligibility requirement associated with an fixed variable. In this embodiment, the system may additionally provide the customer with tips and/or suggestions for improving the fixed variable, in some instances, the system may offer the customer one or more services and/or products for improving the fixed variable. For example, if it is determined that the customer does not satisfy the eligibility requirements due to a low credit score, the system may inform the customer of the reason for denying the application, and provide the customer an option to open a secured credit card maintained by the financial institution that may aid the customer in improving their credit score to become eligible for altering bill payments in the future. In some embodiments, if it is determined that the customer does not satisfy eligibility requirements associated with both fixed and unfixed variables the method may comprise automatically denying the application, and providing the user a combination of offers and/or suggestions to either alter an unfix variable or work towards improving a fixed variable.

At step 330, the system provides the customer an offer for participation in a program/service for altering bill payments. The application may be provided in response to determining the customer satisfies the eligibility requirements for altering bill payments, at step 200. In some embodiments, providing the customer an application may further comprise presenting the offer via a graphical display. The application may be presented in the graphical user interface (GUI) associated with online banking platform.

In some embodiments, the eligibility requirements are assessed for a general population of consumers associated with a particular entity such that a participation offer is subsequently extended to all customers that satisfy the one or more eligibility requirements. In other embodiments, an offer is provided to a customer in response to, or in conjunction with, a customer receiving a new product and/or service provided by an entity. For example, if a customer applies for a credit card maintained by the financial institution, and is approved, the system may determine that the customer also satisfies the eligibility requirements for altering bill payments and additionally provide the customer an offer for participation in the program for altering bill payments.

In some embodiments, if it is determined that the customer does not satisfy an eligibility requirement associated with a unfixed variable the method may comprise at least one of the following additional steps including, offering the customer an option to satisfy the eligibility requirement, receiving the customer's acceptance of the offer to satisfy the eligibility requirement, altering the unfixed variable to satisfy the eligibility requirement in response to receiving the customers' acceptance of the offer, and providing the customer an offer for participation in the program based at least partially on the customer's acceptance of the offer and/or determining the customer now satisfies the eligibility requirement. At step 340, the system may receive the customer's acceptance of the offer. Alternatively, the system may receive a customer denial of the offer.

At step 350, the customer is enrolled in the program/service for altering bill payments either in response to determining the customer satisfies the eligibility requirements for altering bill payments or receiving the customer's acceptance of the offer for participation in the program/service for altering bill payments. Enrolling the customer in the program may further comprise determining conditions for enrollment into the program. The conditions for enrollment may be defined by either one or more terms of agreement for customer participation in the program or one or more rules that define the terms of the service.

In some embodiments, the terms of service may include one or more restrictions associated with the service. In some embodiments, a customer enrolled in the program may be limited to altering a predetermined number of bill payments within a predetermined time period. For example, a customer may be limited to altering three (3) bill payments within a one (1) year period. In another embodiment, the terms of service may be related to conditions for payments additionally assessed to the account in conjunction with a customer making a late payment, hereinafter referred to as late assessments. In one embodiment, the customer may avoid a late assessment by being enrolled in the service and altering their bill payment. In another embodiment, the customer may avoid a late assessment and defer a principle payment by being enrolled in the service and alter their bill payments. In yet another embodiment, the customer may avoid paying a monthly payment by adding to the back end of their loan, but still be responsible for paying a late assessment associated with missing the payment.

In some embodiments, the conditions for enrollment into the program may be based on tiers in which the customers are categorized. Customers in different level tiers may be provided a different degree of service. In one embodiment, customers in a higher level tier may be considered “preferred customers” and offered exclusive benefits associated with the service for altering bill payments. For example, customers in a higher level tier may be eligible to opt out of a payment or defer a bill payment for an entire month, whereas customers in a lower level tier may only be eligible to defer a payment for ten (10) days. Tiers may be determined based on various characteristics associated with the customer such as credit score, income level, and the like. For example, customers with an annual income of $80,000 or above may be considered preferred customers.

In other embodiments, the conditions for enrollment into the program may be related to the length of service. For example the customer may be enrolled in the service for a one-time occurrence or a predetermined number of days, months, years, and the like. The system may periodically reassess the customer's eligibility criteria to determine whether or not they are still eligible for the service. In some embodiments, the system may reassess the customer's eligibility requirements at the end of their enrollment period to determine whether or not they will be further offered the service for another period in the future, or to determine whether or not their conditions for enrollment may change based upon a change associated with the customers financial and/or non-financial history.

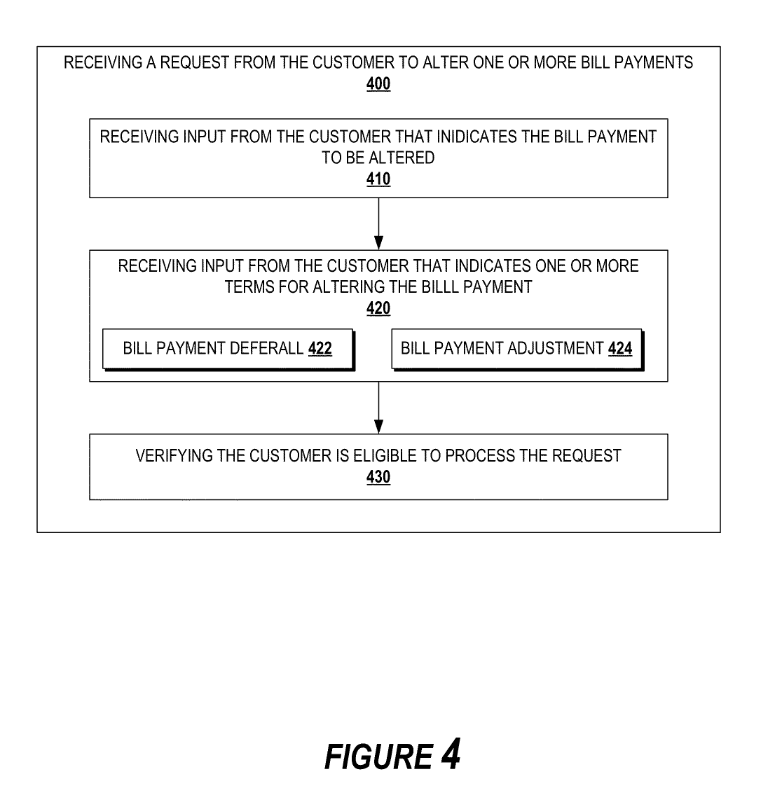

As further illustrated in FIG. 1, at step 400, the method comprises receiving a request from the customer to alter one or more bill payments. As illustrated in FIG. 4, receiving a request from the customer to alter one or more bill payments, at step 400, may comprise one or more additional method steps. The one or more additional method steps may include but not be limited to, receiving a first input from the customer that indicates the bill payment to be altered 410, receiving a second input from the customer that indicates one or more terms for altering the bill payment 420 where altering the bill payment may include either deferring the payment date 422, adjusting the payment amount 424, or a combination of both, and verifying the customer is eligible to process the request 430. Similarly, at step 402, a request may be received from the customer to alter one or more bill payments specifically payable to a third party. It should be noted that step 402 may be executed using one or more of the additional method steps associated with step 400, and described further herein.

At step 410, the system receives a first input from the customer indicating the bill payment to be altered. In some embodiments, the customer may be presented, from within the online banking application, an option to alter one or more bill payments. Likewise, the customer may explicitly request to alter a specific bill payment. In response to opting/requesting to alter a bill payment the customer may be prompted to select a parameter to identify the bill payment that they want to alter. The identifying parameter may include, but not be limited to, the payment date, payment amount, associated product/service, minimum payment amount, remaining balance, and/or a combination of the aforementioned parameters. For example, the customer may request on Jun. 24^{th}, 2013 to alter an upcoming bill payment due on Jul. 1^{st}, 2013 (identifying parameter). The system may then receive the identifying parameter as the first input.

At step 420, the system receives a second input from the customer indicating one or more terms for altering the bill payment. In some embodiments, altering bill payments may refer to altering and/or deferring a due date associated with the bill payments. In this embodiment, the second input may comprise the customer specifying a deferred payment date on which they can pay the current bill due. The system may be configured to receive one or more deferred payment dates on which the customer can pay the current bill. The customer may also specify a number of days in which the customer can pay the current bill. For example, the number of days may be added to the current due date in order to calculate a new deferred due date. In other embodiments, altering bill payments may refer to adjusting the payment amount associated with the bill payments in combination with deferring the due date. In this embodiment, the second input may comprise the customer specifying an initial amount they are able to pay on the original due date, and a remaining amount to be paid on a deferred due date. The system may be configured to receive one or more deferred payment amounts and payment dates on which the customer can pay the current bill.

At step 430, the system verifies the customer is eligible to process the request associated with the one or more terms for altering the bill payment. Verifying the customer is eligible to process the request may comprise determining the customer is adhering to the terms of service specified prior to their enrollment. For example, a lower tiered customer may only be allowed to alter two (2) bill payments within a predetermined period, thus verifying the customer is eligible to process the request may comprise determining the customer has previously altered less than two bill payments. If it is determined that the customer is not eligible to process the request the method may further comprise either denying the customer an altered bill payment, or prompting the customer to redefine one or more terms for altering the bill payment. For example, in some embodiments a customer is only eligible to defer a payment for up to fourteen (14) days. If the customer request to defer a payment due on Jul. 1^{st}, 2013 to Jul. 15^{th}, 2013, the system may determine that the customer is not eligible to process the request, and prompt the customer to select a deferred payment date prior to Jul. 15^{th}, 2013.

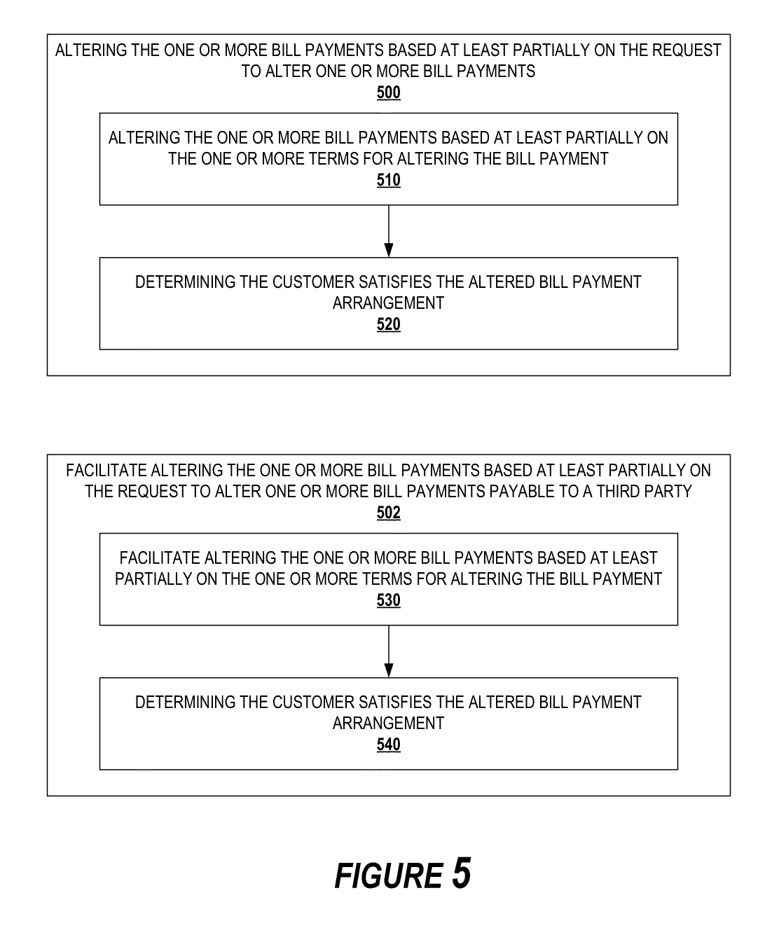

As further illustrated in FIG. 1, at step 500, the method comprises altering the one or more bill payments. In some embodiments, the one or more bill payments are altered based at least partially on the request to alter one or more bill payments. As illustrated in FIG. 5, altering the one or more bill payments, at step 500, may comprise one or more additional method steps. The one or more additional method steps may include but not be limited to, altering the one or more bill payments based at least partially on the one or more terms to alter the bill payment 510, and determining the customer satisfies the altered bill payment arrangement 520.

At step 510, the system alters one or more bill payments based at least partially on the terms specified in the request to alter the bill payment. In an embodiment where the second input comprises the customer specifying a deferred payment date on which they can pay the current bill due, altering the bill payment may comprise at least one additional step, including creating a second payment arrangement associated with the bill payment where the second payment arrangement comprises scheduling the original payment amount to be paid on the deferred payment date, and cancelling the original payment arrangement.

In an embodiment where the second input comprises the customer specifying an initial amount they are able to pay on the original due date, and a remaining amount to be paid on a deferred due date, altering the bill payment may comprise at least one additional step, including altering the original payment arrangement associated with the bill payment where the payment amount associated with the original payment arrangement is reduced to the specified initial amount, and creating a second payment arrangement where the second payment arrangement comprises scheduling a remaining amount scheduled to be paid on the specified deferred payment date.

In some embodiments, the second input may comprise the customer specifying more than one deferred payments dates and an amount to be paid on each deferred payment date. In this embodiment, the method may comprise at least one of the following additional steps including, but not limited to, receiving a second input from the customer specifying a first deferred payment date, a first deferred payment amount, at least one second deferred payment date, and at least one second deferred payment amounts, creating a second payment arrangement associated with the bill payment where the second payment arrangement comprises scheduling the first deferred payment amount to be paid on the first deferred payment date, creating at least one additional payment arrangements associated with the bill payment where the additional payment arrangement comprises scheduling at least one second deferred payment amount to be paid on the at least one second deferred payment date, wherein the sum of the first and the at least one second payment amounts equal the original payment amount, and cancelling the original payment arrangement.

In some embodiments, the customer may defer the entire payment arrangement versus postponing the payment arrangement to another date. For example, if the respective debt product is a loan the customer may defer one or more of the upcoming loan payments, however the customer may still be responsible for paying the interest on the loan during the deferral period. In this embodiment, the method may comprise at least one of the following additional steps including, but not limited to, receiving a first input from the customer specifying one or more bill payments to be deferred, cancelling one or more original payment arrangements, and adding the interest associated with the one or more deferred bill payments to the principle balance of the debt product.

At step 520, the system determines whether or not the customer satisfies the altered bill payment arrangement. In some embodiments, if the system determines that a customer has failed to satisfy the altered payment arrangement the customer may no longer be eligible to alter future bill payments.

As further illustrated in FIG. 1B, at step 502, the method comprises facilitating altering the one or more bill payments payable to a third party. It should be noted that altering payments payable to a third party may be executed similarly to the method of step 510, and may include one of more steps specific to integrating a third party service provider. In some embodiments, the one or more bill payments are altered based at least partially on the request to alter one or more bill payments. As illustrated in FIG. 5, altering the one or more bill payments, at step 500, may comprise one or more additional method steps. The one or more additional method steps may include but not be limited to, altering the one or more bill payments based at least partially on the request to alter the bill payment 530, and determining the customer satisfies the altered bill payment arrangement 540.

At step 530, the system facilitates altering one or more bill payments payable to a third party based at least partially on the terms specified in the request to alter the bill payment. In one embodiment, facilitating altering the bill payments payable to a third party may comprise the financial institution upholding the original bill payment arrangement with the third party on behalf of the customer and the customer repaying the financial institution according to an altered payment arrangement. In this embodiments, the method may comprise one or more additional steps, including but not limited to, paying the third party the minimum amount due on the original payment due date, creating a second payment arrangement associated with the bill payment where the second payment arrangement comprises scheduling the payment amount to be repaid to the financial institution on the deferred payment date.

In one embodiment, facilitating altering the bill payments payable to a third party may comprise the financial institution negotiating an altered payment arrangement with third party on behalf of the customer and covering any late payments associated with the customer paying the bill at a later date. The financial institution may additionally be responsible for upholding the altered payment arrangement in an instance that the customer fails to pay on the altered payment date In this embodiments, the method may comprise one or more additional steps, including but not limited to, creating a second payment arrangement associated with the bill payment where the second payment arrangement comprises scheduling the original payment amount to be paid to the third party on the deferred payment date, sending the payment arrangement to the third party, determining, at step 540, whether the customer satisfied the altered bill payment arrangement, and paying the third party a late payment. If it is determined that the customer did not satisfy the altered payment arrangement, the financial institution may additionally be responsible for paying the third party the minimum payment amount, and receiving the payment from the customer at a later date. In some embodiments, the financial institution may cover any late payments associated with bill payments that are currently in the past due stage, where the customer was not able to make an altered payment arrangement in a timely fashion.

In some embodiments, the third party may directly send the bill to the financial institution in addition to the customer, such that the financial institution has all the necessary component in order to facilitate altering one or more bill payments payable to the third party, and creating altered payment arrangements on behalf of the customer.

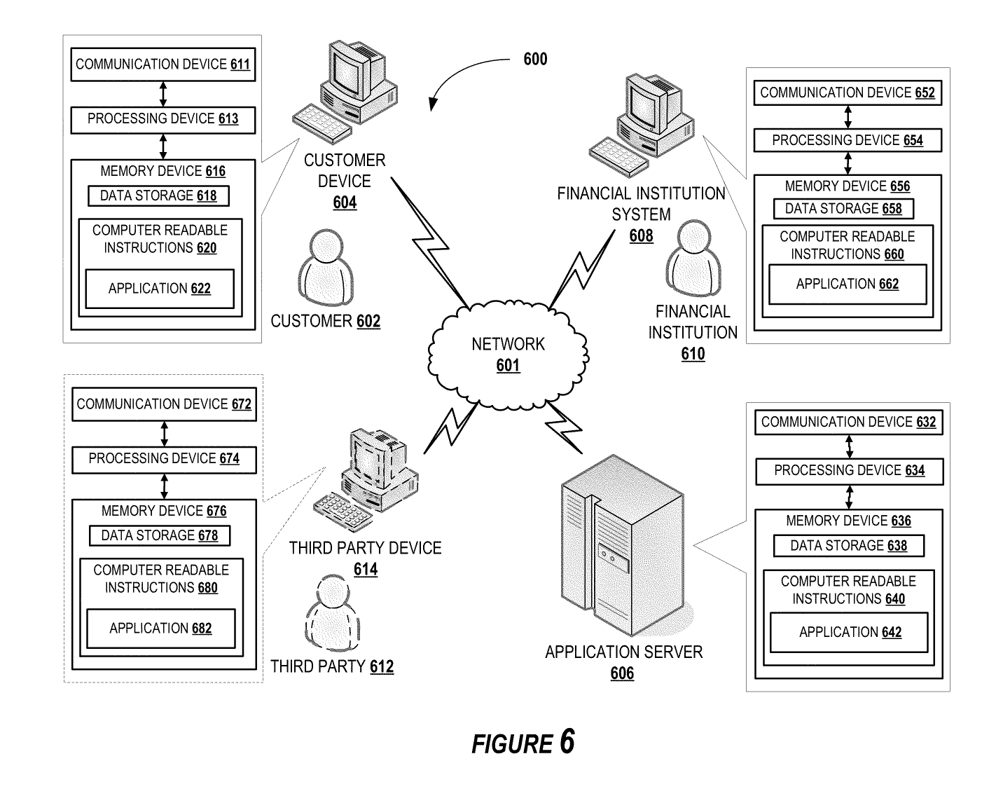

Referring now to FIG. 6, a system environment for altering bill payments 600, in accordance with one embodiment of the present invention, is illustrated. As shown, the financial institution system 608 is capable of sending and/or receiving information from the application server 606. Likewise, the application server 606 is capable of sending and/or receiving information from the customer device 604 and optionally the third party device 614. This communication may occur across the network 601. The network 601 may be a global area network (GAN), such as the Internet, a wide area network (WAN), a local area network (LAN), or any other type of network or combination of networks. The network 601 may provide for wireline, wireless, or a combination wireline and wireless communication between devices on the network.

The application server 606 may include a processing device 634. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The application server 606 may further include a communication device 632 that is operatively coupled to the processing device 634. The communication device 632 is capable of sending information related to altering bill payments to either the customer device 204 and/or financial institution system 608 in response to determining that the customer 602 satisfies the eligibility requirements for altering bill payments. The processing device 634 uses the communication device 632 to communicate with the network 601 and other devices on the network 601, such as, but not limited to, the financial institution system 608, customer device 604, and third party device 614. The communication device 632 generally comprises a modem, server, or other device for communicating with other devices on the network 601.

The processing device 634 is also operatively coupled to the memory device 636. The memory device 636 may house computer-readable instructions 640 which may include a server application 642. In some embodiments, the memory device 636 includes data storage 638 for storing data related to the system environment for altering bill payments 600 including, but not limited to, data used by the server application 642, or information provided by the customer 602, customer device 604, third party 612, third party device 614 and/or financial institution system 608. For example, the data storage 638 may store all information related to the eligibility requirements of the third party 612. The server application 642 may then send the stored eligibility requirements to the financial institution system 608, and/or determine that a customer satisfies the eligibility requirements.

The application server 606 may be operatively coupled over a network 601 to the customer device 604, and, in some embodiments, to the financial institution system 608 or third party device 614. The financial institution system 608 may include an end system and/or interface used by a business, such as a computer terminal. It should also be noted, in some embodiments the customer device 604 may be interchanged with other end consumer systems, such as a mobile device. In this way, the application server 606 can send information to and receive information from the customer device 604, the financial institution system 608, and the third party device 614 to facilitate altering bill payments on behalf of the customer 602 based on information provided by various sources discussed herein. FIG. 6 illustrates only one example of an embodiment of a system environment for altering bill payments 600, and it will be appreciated that in other embodiments one or more of the systems, devices, or servers may be combined into a single system, device, or server, or be made up of multiple systems, devices, or servers.

In the embodiment illustrated in FIG. 6, the server application 642 may enable the customer 602, the financial institution 610 and/or third party 614 to interact with the system. First, the server application 642 enables a customer 602 to provide information indicating a need for altering bill payments to the financial institution 610, via the customer device 604. Next, the server application 642 enables the financial institution 610 to access the customer's financial data for use in determining whether the customer satisfies the eligibility requirements for altering bill payments. The server application 642 may be capable of sending and/or receiving information to and from the customer device 604, the financial institution system 608, and third party system 614. For example, a customer device 604 may indicate that the customer 602 is interested in enrolling in program/service for altering bill payments.

The financial institution system 608 generally includes a communication device 252, a processing device 654, and a memory device 656. The processing device 654 is operatively coupled to communication device 652, and the memory device 656. The financial institution system 608 may include an input device such as a keyboard device to receive information from an individual associated with the financial institution system 608. The financial institution system 608 may additionally include a reader device including, but not limited to, a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device receives information that may be used to communicate instructions via the communication device 652 over a network 601, to other systems such as, but not limited to the application server 606 and/or other systems. The communication device 652 generally comprises a modem, server, or other device for communicating with other devices on the network 601.

The financial institution system 608 includes computer-readable instructions 660 stored in the memory device 656, which in one embodiment includes an application 662. A financial institution system 608 may also refer to any device used to provide information, messages and/or communicate to be sent to a customer 602 or the application server 606, including but not limited to, information related to a customer 602 altering one or more bill payments. In some embodiments, the financial institution system 608 may refer only to a plurality of components. For example, the financial institution system 608 may refer to a customer device, or a customer device, third party device and a financial institution device interacting with one another to provide altered bill payments. As used herein, the financial institution may also be interchanged with a system associated with the third party entity.

In some embodiments, the financial institution system 608 may serve as an interface between a financial institution 610 and the application server 606, customer device 604, or third party device 614 to enable a financial institution to alter one or more bill payments on behalf of the customer. In some embodiments, the financial institution system 608 is or includes an interactive computer terminal that is configured to initiate, communicate, process, and/or facilitate altering bill payments for the customer 602. A financial institution system 608 could be or include any device that may be used to communicate with a customer 602 or the application server 606, such as, but not limited to, a digital sign, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, music-playback device, personal GPS device, etc.), a financial institution terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, the financial institution system 608 may be operated in a public place (e.g., on a street corner, at the doorstep of a private residence, in an open market, at a public rest stop, etc.). In other embodiments, the financial institution system 608 is additionally or alternatively operated in a place of business (e.g., in a retail store, post office, banking center, grocery store, factory floor, etc.). In accordance with some embodiments, the financial institution system 608 may not be operated by the customer of the financial institution system 608. In some embodiments, the financial institution system 608 is operated by a mobile business operator or a POS operator (e.g., merchant, vendor, salesperson, etc.). In yet other embodiments, the financial institution system 608 is owned by the entity offering the financial institution system 608 providing functionality in accordance with embodiments of the invention described herein.

FIG. 6 also illustrates a customer device 604. The customer device 604 may include a communication device 611, a processing device 613, and a memory device 616. The processing device 613 is operatively coupled to the communication device 611 and the memory device 616. The processing device 613 uses the communication device 616 to communicate with the network 601 and other devices on the network 601, such as, but not limited to, the application server 606, the financial institution system 608, and the third party device 614. The communication device 616 generally has a modem, server, or other device for communicating with other devices on the network 601.

The customer device 604 may have computer-readable instructions 620 stored in the memory device 616, which in one embodiment includes the customer application 622. Application 622 may cause the processing device to send and receive information related to the customer 602 altering one or more bill payments. The customer device 604 may also include data storage 618 located in the memory device 616. The data storage 618 may be used to store information related to information related to the customer's 602 personal data. A “customer device” 204 may or include any computer, (e.g., a personal computer, tablet computer, desktop computer, server, laptop, etc.), mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single customer device 604 is depicted in FIG. 6, the system 600 may contain numerous mobile devices, similar to customer device 604.

FIG. 6 also illustrates a third party device 614. The third party device 614 may include a communication device 672, a processing device 674, and a memory device 676. The processing device 674 is operatively coupled to the communication device 672 and the memory device 676. The processing device 674 uses the communication device 676 to communicate with the network 601 and other devices on the network 601, such as, but not limited to, the application server 606, the financial institution system 608, and the customer device 604. The communication device 676 generally has a modem, server, or other device for communicating with other devices on the network 601.

The third party device 614 may have computer-readable instructions 680 stored in the memory device 676, which in one embodiment includes the third party application 682. Application 682 may cause the processing device to send and receive information related to the third party 612 allowing one or more bill payments to be altered. The third party device 614 may also include data storage 678 located in the memory device 676. The data storage 618 may be used to store information related to information related to the third parties 612 eligibility requirements for altering bill payments. A “third party device” 614 may or include any end system and/or interface used by a merchant, such as a computer terminal, a computer, (e.g., a personal computer, tablet computer, desktop computer, server, laptop, etc.), mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like. Although only a single third party device 614 is depicted in FIG. 6, the system 600 may contain numerous mobile devices, similar to third party device 614.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for altering bill payments, the apparatus comprising:
a memory;
a processor; and
a module stored in the memory, executable by the processor, and configured to:
determine a customer satisfies eligibility requirements for altering bill payments;
provide an option for the customer to participate in a service for altering bill payments based at least partially on determining the customer meets the eligibility requirements for altering bill payments;
receive a request from the customer to alter a bill payment, wherein the bill payment is associated with an original payment arrangement having an original amount due on an original payment due date; and
alter the bill payment based at least partially on the request to alter the bill payment.

2. The apparatus of claim 1, wherein the module is further configured to:
receive a first input from the customer, wherein the first input indicates the bill payment to be altered;
receive a second input from the customer, wherein the second input indicates one or more terms for altering the bill payment; and
alter the bill payment based at least partially on the one or more terms for altering the bill payment.

3. The apparatus of claim 2, wherein the second input comprises a deferred payment date.

4. The apparatus of claim 3, wherein the module is further configured to:
create a second payment arrangement associated with the bill payment wherein creating the second payment arrangement comprises scheduling the original amount due to be paid on the deferred payment date; and
cancel the original payment arrangement.

5. The apparatus of claim 1, wherein the second input comprises a deferred payment date, an initial payment amount, and a remaining payment amount.

6. The apparatus of claim 5, wherein the module is further configured to:
alter the original payment arrangement associated with a bill payment wherein altering the original payment arrangement comprises reducing the original amount due to the initial payment amount; and
create a second payment arrangement wherein creating the second payment arrangement comprises scheduling the remaining payment amount to be paid on the deferred payment date.

7. The apparatus of claim 1, wherein the second input comprises a primary deferred payment date, a primary deferred payment amount, at least one secondary deferred payment dates, and at least one secondary deferred payment amounts.

8. The apparatus of claim 7, wherein the module is further configured to:
create a second payment arrangement associated with the bill payment wherein creating the second payment arrangement comprises scheduling the primary deferred payment amount to be paid on the primary deferred payment date; and
create at least one additional payment arrangement associated with the bill payment wherein creating the at least one additional payment arrangement comprises scheduling at least one secondary deferred payment amounts to be paid on at least one secondary deferred payment dates;
wherein the sum of the primary deferred payment amount and the at least one secondary payment amount equals the original amount due; and
cancel the original payment arrangement.

9. The apparatus of claim 1, wherein the module is further configured to:
determine one or more conditions for enrollment; and
enroll the customer in a service for altering bill payments based at least partially on the one or more conditions for enrollment.

10. The apparatus of claim 9, wherein the module is further configured to categorize the customer into a tier based at least partially on one more characteristics associated with customer, and wherein the one or more conditions for enrollment are determined based at least partially on the customer's tier.

11. The apparatus of claim 1, wherein the module is further configured to assess one or more financial characteristics associated with the customer to determine the customer meets the eligibility requirements to alter bill payments.

12. The apparatus of claim 1, wherein the module is further configured to assess one or more non-financial characteristics associated with the customer to determine the customer meets the eligibility requirements to alter bill payments.

13. The apparatus of claim 1, wherein the module is further configured to:
determine the customer does not satisfy at least one eligibility requirement for altering bill payments;
provide the customer an offer, wherein acceptance of the offer results in the customer satisfying the at least one eligibility requirement; and
determine the customer satisfies the eligibility requirements for altering bill payments based at least partially on the customer's acceptance of the offer.

14. The apparatus of claim 1, wherein the module is further configured to:
determine the customer does not satisfy at least one eligibility requirement for altering bill payments;
provide the customer an offer, wherein acceptance of the offer results in the customer satisfying the at least one eligibility requirement; and
determine the customer does not satisfy the eligibility requirements for altering bill payments based at least partially on the customer's denial of the offer.

15. The apparatus of claim 1, wherein the module is further configured to verify the customer is eligible to process the request to alter one or more bill payments.

16. A method for altering bill payments, the method comprising:
determining a customer meets the eligibility requirements for altering bill payments;
providing an option for the customer to participate in a service for altering bill payments based at least partially on determining the customer meets the eligibility criteria for altering bill payments;
receiving a request from the customer to alter a bill payment, wherein the bill payment is associated with an original payment arrangement having an original amount due on an original payment due date; and
altering the bill payment based at least partially on the request to alter the bill payment.

17. The method of claim 16, the method further comprising:
receiving a first input from the customer, wherein the first input indicates the bill payment to be altered;
receiving a second input from the customer, wherein the second input indicates one or more terms for altering the bill payment; and
altering the bill payment based at least partially on the one or more terms for altering the bill payment.

18. The method of claim 16, the method further comprising:
determining the customer does not satisfy at least one eligibility requirement for altering bill payments;
providing the customer an offer, wherein acceptance of the offer results in the customer satisfying the at least one eligibility requirement; and
determining the customer satisfies the eligibility requirements for altering bill payments based at least partially on the customer's acceptance of the offer.

19. A computer program product for altering bill payments, the computer program product comprising:
a non-transitory computer-readable medium comprising a set of codes for causing a computer to:
determine a customer meets the eligibility requirements for altering bill payments;
provide an option for the customer to participate in a service for altering bill payments based at least partially on determining the customer meets the eligibility criteria for altering bill payments;
receive a request from the customer to alter a bill payment, wherein the bill payment is associated with an original payment arrangement having an original amount due on an original payment due date; and
alter the bill payment based at least partially on the request to the bill payment.

20. The computer program product of claim 18, the computer program product further comprising a set of codes for causing a computer to:
receive a first input from the customer, wherein the first input indicates the bill payment to be altered;
receive a second input from the customer, wherein the second input indicates one or more terms for altering the bill payment; and
alter the bill payment based at least partially on the one or more terms for altering the bill payment.

21. The computer program product of claim 18, the computer program product further comprising a set of codes for causing a computer to:
determine the customer does not satisfy at least one eligibility requirement for altering bill payments;
provide the customer an offer, wherein acceptance of the offer results in the customer satisfying the at least one eligibility requirement; and
determine the customer satisfies the eligibility requirements for altering bill payments based at least partially on the customer's acceptance of the offer.
